(19) United States
(12) Patent Application Publication
(10) Pub. No.: US 2020/0077623 A1
(43) Pub. Date: Mar. 12, 2020

(54) Nipple System for Delivering Fluid to an Animal

(71) Applicants: Bertrand Dumont, Portsmouth, RI (US); Stephane Dumont, Boston, MA (US)

(72) Inventors: Bertrand Dumont, Portsmouth, RI (US); Stephane Dumont, Boston, MA (US)

(21) Appl. No.: 16/126,632

(22) Filed: Sep. 10, 2018

(51) Int. Cl. A01K 9/00

(52) U.S. Cl. CPC A01K 9/005

(57) ABSTRACT

The present disclosure refers to an apparatus for feeding an infant animal has in one embodiment a nipple combination comprising a one-way valve engaged with the proximal end of the tube of a nipple, and an open rather than self-sealing nipple aperture. A self-sealing nipple aperture is obviated by the one-way valve in the distal end of the tube of the nipple.

### TECHNICAL FIELD

The invention relates in general to teats or nipples for animals; teats having means for regulating the flow rate by size or shape of the opening; teats with means for fastening to bottles with interlocking means; and teats with means for supplying air without dripping fluid.

### BACKGROUND

Feeding infant dairy animals frequently involves the use of imitation teats attached to liquid containers. A common apparatus is a bottle with an elastomeric nipple attached. Such nipples are commonly tube-like with a larger-diameter base. The base attaches to a bottle or other container. The tube approximates the size and shape of a teat, having a proximal end in fluid communication with the base and a distal end for dispensing liquid. The distal end of common tubes has an orifice, also referred to as an aperture, that is designed to self-seal to prevent leakage. A cross-shaped cut in the distal end of the tube is a common, self-sealing orifice, or aperture, when used with rubber nipples or other elastomeric materials used for nipples.

A conventional nipple attached to a bottle seals the opening of the bottle and allows liquid to flow through a self-sealing orifice, also referred to as a nipple aperture, in the distal end of the tube. Self-sealing orifices are commonly a cross-shaped cut in the distal end of the tube. As a calf suckles the tube, liquid is drawn from inside the nipple, creating a partial vacuum, or lower-than-ambient pressure inside the bottle.

A one-way valve, otherwise referred to as a check valve, is a valve which allows a gas or fluid to flow in one direction. Commonly, an air vent is molded into the nipple with a cut into the nipple after molding. The air vent closes to prevent fluid leakage because of pre-stress in the material before the slit is cut.

A flow control valve is a valve which prevents fluid flow until a certain differential pressure is achieved. In a flow control valve, the valve material is designed to flex back to the original, closed position below a certain differential pressure. A flow control valve is a commonly used valve in the food industry and is often seen in bottles that dispense condiments such as ketchup or mustard.

Thermoplastic elastomers (TPE) are also referred to as thermoplastic rubbers or castable elastomers and are a class of copolymers or physical mix of polymers which provide a combination of the properties of the mixed components. For example, a thermoplastic or injection-moldable plastic combined with a rubber provides an injectable rubber material.

The shape of the nipple, shape of the aperture and the shape of the vent can affect the flow rate of the nipple. Specifically for animal feeding, keeping a uniform flow rate is important, as drinking fluid too quickly can cause an animal bowel and intestinal issues, and too slow of a flow rate can frustrate the animal, and cause the farm worker to spend too much time feeding an animal. Commonly, the flow rate can increase due to damage to the nipple aperture, eventually resulting in discarding a nipple which has too large an aperture.

The wear of the nipple aperture and the shape of the air vent can affect nipple leakage. Leakage can be caused by a lack of pressure differential inside the bottle, liquid drips out of the nipple. Leakage also occurs when an aperture eventually fails to close because of material tearing (due to, for example, an infant animal chewing it during feeding), or general wear or reduced resiliency. Leakage also can occur through the air vent if the head pressure of the fluid within the bottle exceeds the capacity of the air vent to prevent leakage.

### SUMMARY

An apparatus for feeding an infant animal has in one embodiment a nipple combination comprising a flow control valve engaged with the proximal end of the tube of a nipple and a vertically oriented tube extending upward from the base toward an upper end, terminating within a nipple housing that has an open feeding orifice. A common cavity is formed by the flexible wall of the inner diameter of the vertically extending tube and its upper end. An elastomeric check valve air vent prevents milk from leaking out of the bottle. In some embodiments the check valve is molded into the elastomeric material that comprises the base. A base is designed to engage with common types of animal feed vessels. In some embodiments the base of the nipple is designed to snap onto a vessel. In other embodiments the base of the nipple is mated with a collet that threads onto the throat of a vessel to engage the base of the nipple with the collet and so with the vessel.

The upper end of the tube resides in a half-spherical nipple. The half-spherical end has an open rather than self-sealing nipple aperture of no less than one millimeter to no more than 5 millimeters in diameter. The need for a self-sealing nipple aperture is obviated by the valve in the distal end of the tube of the nipple combination of the present disclosure.

In one embodiment a TPE flow control valve resides in an insert which is in the base of the tube portion of the nipple and prevents leakage. The flow control valve is a flanged cylindrical form. A cut in the bottom of the flanged cylinder opens when the pressure at the distal end of the nipple is greater than the pressure inside the fluid feed vessel. The pressure differential required to open the flow control valve may be regulated by the design of the flanged cylindrical shape, the thickness of the elastomeric material and the size of the cut(s) that make up the valve opening. In some embodiments the flow control valve is designed to hold a head pressure between 20 cm H₂O and 70 cm H₂O and preferably about 40 to 50 cm H₂O. Being situated in the base the valve is separated from and avoids damage caused by the feeding infant animal, and obviates the need for a cross-cut aperture at the end of the nipple, instead affording an open orifice. Furthermore, locating the valve in the base of the nipple allows for a more delicate valve that can have a uniform flow rate by maintaining its integrity. Since the valve is not in contact with the animal's mouth, it does not incur wear during feeding and the system may be more precisely designed for a specific flow rate while maintaining consistency far longer than a valve at the aperture of the nipple.

A flow control valve holding a head pressure of up to 50 cm H₂O requires a moldable air vent check valve capable of preventing fluid leakage with such head pressures. One embodiment of this check valve involves a blister form, otherwise referred to as spherical form or semi-spherical form, that is molded into the base of the nipple. The blister form has a single slit cut into it to create the valve. The blister form has at least one protrusion(s) molded into the nipple base along which the slit is cut. These protrusions are designed to increase the amount of material around the slit thereby strengthening the slit and preventing its leakage in high head pressures.

The aforementioned features provide a nipple that does not leak when not being suckled by an infant animal. Only the suckling motion of the infant animal results in the flow of liquid feed through the nipple. Liquid flow through the nipple is precisely controlled by a valve that does not reside in the mouth of the animal and therefore is protected from wear. This allows for the use of an orifice that is normally open in the tip of the nipple, thus providing a significant increase in the life of the nipple and precise control of the flow of liquid feed.

Other objects and features will become apparent from the following detailed description considered in conjunction with the accompanying drawings. The drawings are designed to illustrate rather than define of the limits of the invention.

### BRIEF DESCRIPTION OF THE DRAWINGS

To assist those of skill in the art in making and using the disclosed invention and associated methods, reference is made to the accompanying figures, wherein:

FIG. 1 is a perspective view of an example embodiment of the nipple combination of the present disclosure

FIG. 2 is an exploded, perspective view of nipple combination.

FIG. 3 is a detailed section view of the nipple combination shown inactive.

FIG. 4 is a detailed section view of the nipple combination shown in use.

FIG. 5 is an exploded view of a second iteration of the embodiment wherein a threaded collet is used to engage the nipple with a vessel.

### DESCRIPTION

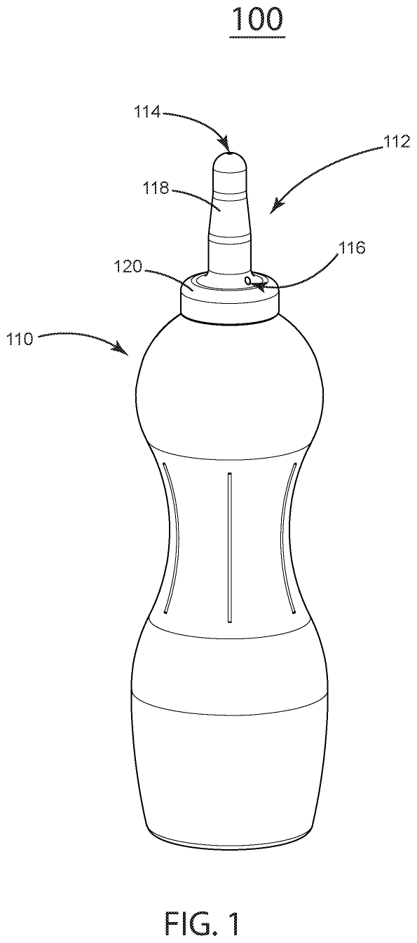

In FIG. 1, a perspective view of an example embodiment 100 shows a provided bottle 110, a nipple combination 112, aperture 114, vent 116, tube 118, plenum 131 and base 120. The aperture 114 is also referred to as an orifice.

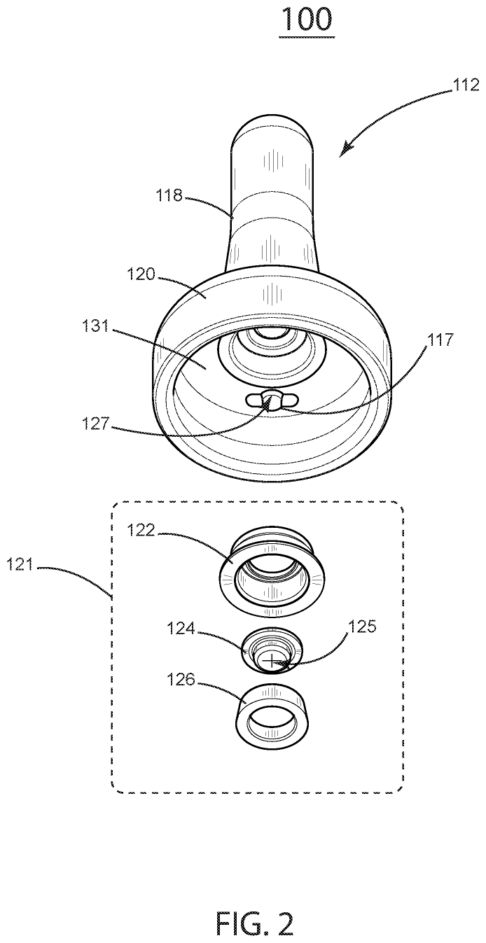

In FIG. 2 the nipple combination 112 is shown in exploded view. An elastomeric valve 124 has a flexible valve aperture 125 cut in a cross. The valve124 is held by a retaining ring 126 housed in a fitting 122 engaged with the opening in the interior of the nipple combination 112. The fitting 122, valve 124 and retaining ring 126 assemble to comprise an insert 121. A flapper valve 117 covers a vent allows air into the bottle to equalize the pressure while the animal is drawing liquid from the tube 118 of the nipple combination 112. Surrounding the nipple combination, a plenum 131 and base 120 are designed to engage with any variation of vessel, including a bottle. The flapper valve 117 is a spherical form having molded structures on at least two sides as shown. A cut 127 in the spherical form provides an opening.

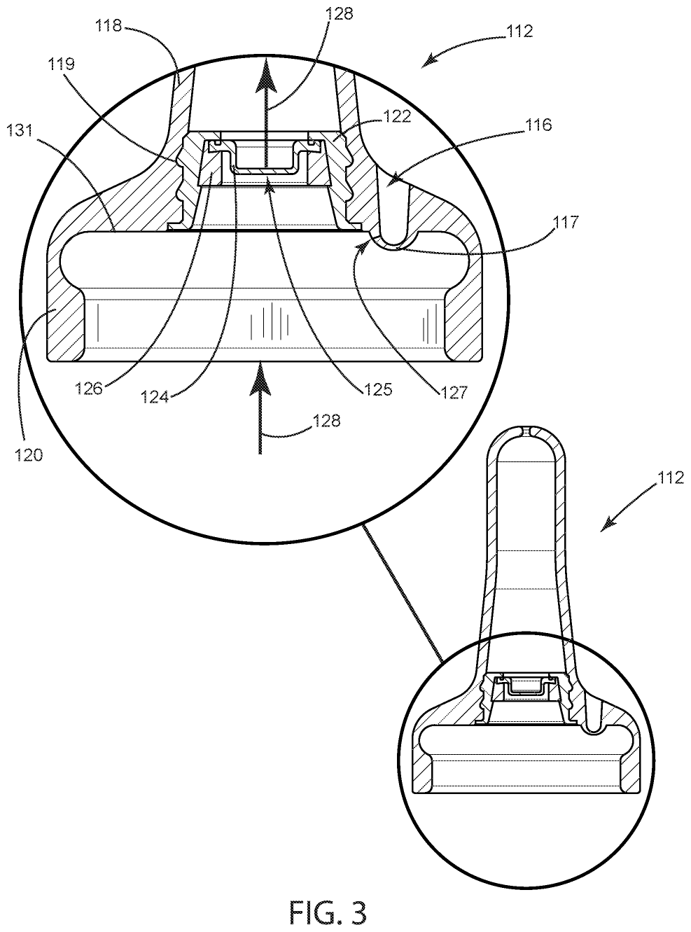

In FIG. 3, a detailed section view of the nipple combination 112 shows it inactive, with its aperture 114 and vent 116 closed and a flapper valve 117 in the vent closed. The flapper valve 117 is comprise of a spherical shape 117 having a cut 127 in the spherical shape 117. Common flapper valves are a flat portion covering a vent such as that of 116. The spherical shape 117 provides greater surface area than a flat counterpart. The forces that open or close the flapper valve are dependent on the pressure per surface area of the flapper valve. Greater surface area provides more pulling force (in a direction opening the vent) when there is a less than atmospheric pressure inside the bottle and a greater closing force to prevent leakage.

Furthermore, flexing a spherical form requires more force than flexing a flat form as the spherical form requires greater deformation of material to flex than that of a flat form.

Referring again to FIG. 3, the elastomeric valve 124 is stationary (not flexed); the flexible valve aperture 125 is unopened. The fitting 122, tube 118, plenum 131, base 120, retaining ring 126, and provided bottle 110 are shown for reference. In this view the shape of the valve 124 can be seen. The cylindrical form 123 and flange 121 are shown. The flange 121, and therefore the valve 124, is engaged in the tube 118 by way of a fitting 122 and retaining ring 126. The fitting 122 is engaged to the tube by at least one annular barb 119. The flange 121 of the valve 124 is held fast against the fitting by a retaining ring 126 that is snap fit into the fitting.

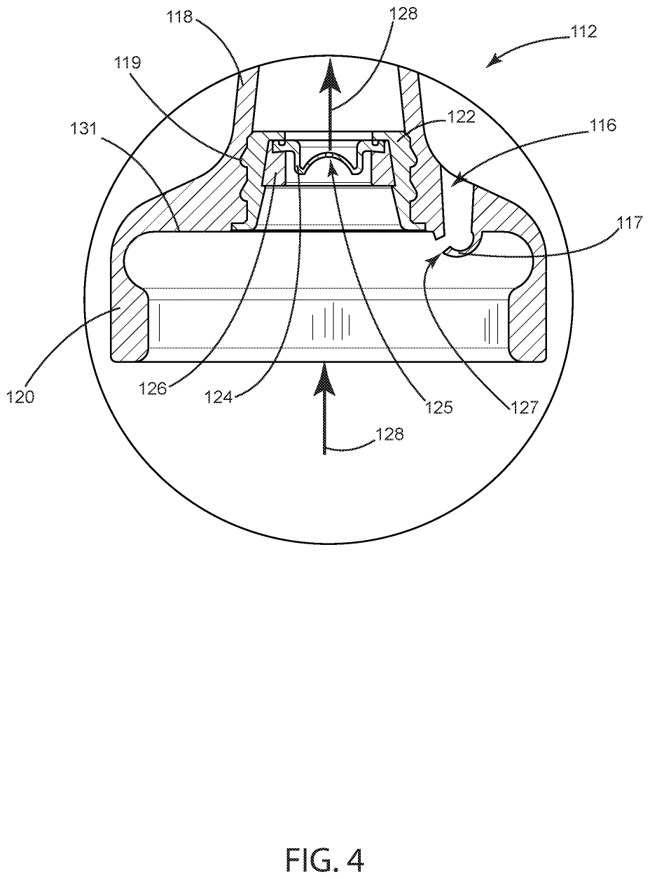

In FIG. 4, the nipple combination 112 is shown during use, with its valve 125 and vent 116 open wherein flapper valve 117 is in the open position. The fluid flow, in this example is in the direction of arrows 128. The elastomeric valve 124 is flexed; thus opening the flexible valve aperture 125. It can be seen that the shape of the valve 124 including the depth of the cylindrical wall 123, the thickness of the material and the diameter of the flange 121 can affect the amount of pressure required to flex the valve and open the aperture 125. The fitting 122, tube 118, plenum 131, base 120, retaining ring 126, and provided bottle 110 are shown for reference. In this example, the direction of liquid flow is indicated by arrow 128.

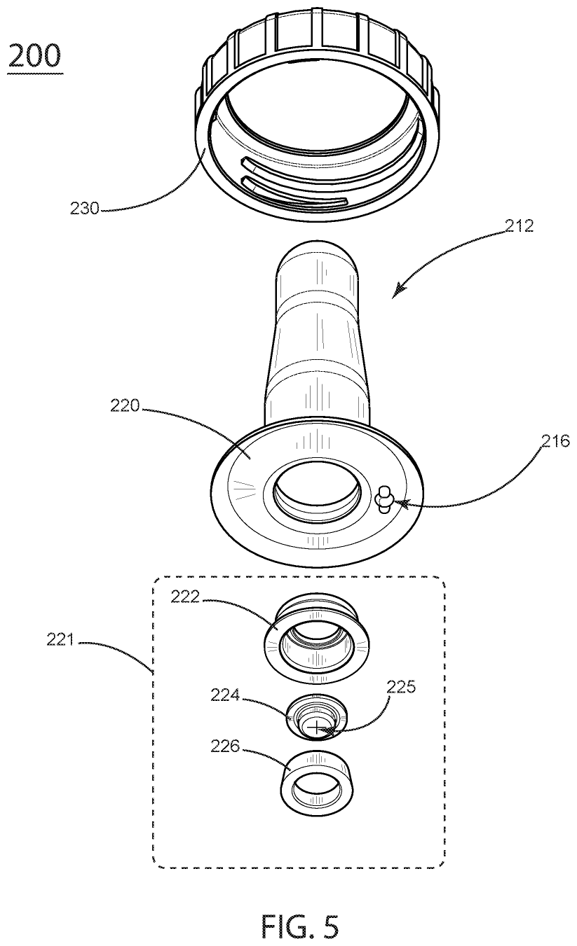

In FIG. 5 the nipple combination 212 is shown in exploded view. An elastomeric valve 224 has a flexible valve aperture 225 cut in a cross. The valve is held by a retaining ring 226 housed in a fitting 222 engaged with the opening in the interior of the nipple combination 212. The fitting 222, valve 224 and retaining ring 226 assemble to comprise an insert 221. A vent 216 allows air into the bottle to equalize the pressure while the animal is drawing liquid from the tube 218 of the nipple combination 212. Surrounding the nipple combination, a threaded coupling 230 is designed to engage with any variation of vessel having a threaded top, including a bottle.

One skilled in the art understands that the bottle is shown for reference; the nipple combination is designed to fit on varying types of vessel.

These embodiments should not be construed as limiting; additions and modifications to what is expressly described herein are understood to be included within the scope of the invention.

1. A nipple for feeding a young non-human animal, the nipple comprising:
a hollow upper portion having a tip and a base; and
a hollow lower portion having a plenum and a bottom; and
the tip of the upper portion having an orifice; and
a flow control valve engaged with the base of the hollow upper portion; and
the base of the upper portion fixedly engaged with the plenum of the lower portion; wherein
the base of the lower portion engages with a vessel for containing liquid feed for young non-human animals, the flow control valve preventing dripping of said liquid in said vessel and residing outside of the mouth of the animal during feeding.

2. The nipple of claim one wherein;
the orifice is normally open.

3. The nipple of claim one further comprising:
a spherical elastomeric air vent check valve engaged with the plenum of the lower portion for allowing the passage of air into said vessel as liquid is removed through said orifice by said young non-human animal during feeding; and
the air vent check valve configured to prevent leakage from head pressures of up to 70 cm H₂O.

4. The nipple of claim one wherein the flow control valve comprises a flanged cylinder; and
at least one cut in a closed end of said cylinder; and
said flange engaged with a fitting that is in turn engaged with said nipple upper portion proximal to said base; and
the flanged cylinder and cut provide a valve configured to hold up to 70 cm H₂O;
wherein
a pressure greater than the flow control valve configured pressure causes the cylinder to deform and the cut to open allowing fluid to flow through.

5. The nipple of claim one wherein the flow control valve comprises:
a flanged cylinder; and
the flanged cylinder end, providing an elastomeric surface; and
said elastomeric surface having a cut opening proximal to the center of the surface; and
said flange of said flanged cylinder is engaged with a substantially rigid annular fitting; and
said flange and annular fitting combination are fixedly engaged with said hollow lower portion proximal to said plenum; wherein
fluid flowing from said vessel through said nipple passes through said valve when under greater than atmospheric pressure.

6. The nipple of claim one further comprising:
a collet threaded to mate with a threaded throat of a container; and
said collet engaging the plenum against the throat of said container to seal the nipple to said container.

7. A nipple for feeding a young non-human animal, the nipple comprising:
a hollow upper portion having a tip and a base; and
a hollow lower portion having a plenum and a bottom; and
the tip of the upper portion having an orifice; and
the base of the upper portion fixedly engaged with the plenum of the lower portion; and
the hollow area of the upper portion in fluid communication with the hollow area of the lower portion; and
a receptacle for a fitting between said upper portion and said lower portion proximal to the engagement between the base of the upper portion and the plenum of the lower portion; and
a valve fixedly engaged with said fitting; and
a retaining ring fixedly engaging said valve in said fitting; wherein
the valve is sealed around the inner walls of the hollow upper portion and allows fluid to flow from the vessel, out through the orifice when a pressure differential occurs between the outside of the orifice and the interior of the vessel.

8. The nipple of claim seven wherein the orifice is normally open.

9. The nipple of claim seven further comprising:
an air vent check valve comprising:
an elastomeric hollow spherical central form; and
molded buttress forms extending from said hollow spherical central form; and
a cut in said elastomeric hollow spherical central form providing an air vent check valve engaged with the plenum of the lower portion for allowing the passage of air into said vessel as liquid is removed through said orifice by said young non-human animal during feeding; and
the air vent check valve configured to prevent leakage from head pressures up to 70 cm H₂O; wherein
the spherical form combined with buttress forms provides sufficient surface area and sufficient stiffness to provide the rigidity to prevent leakage from head pressures of up to 70 cm H₂O.

10. The nipple of claim seven wherein the flow control valve is configured to hold a pressure up to 70 cm H₂O.

11. The nipple of claim seven further comprising:
a collet threaded to mate with a threaded throat of a container; and
said collet engaging the plenum against the throat of said container to seal the nipple to said container.
